(19) United States
(12) Patent Application Publication
(10) Pub. No.: US 2024/0111957 A1
(43) Pub. Date: Apr. 4, 2024

(54) ELECTRONIC DEVICE FOR PROVIDING REAL-TIME EMOTIONAL FEEDBACK TO USER'S WRITING, METHOD THEREOF AND CLASSIFICATION SEVER FOR ANALYZING REAL-TIME EMOTIONAL FEEDBACK

(71) Applicant: AJOU UNIVERSITY INDUSTRY-ACADEMIC COOPERATION FOUNDATION, Suwon-si (KR)

(72) Inventors: Tae-Sun CHUNG, Seongnam-si (KR); Inyoung PARK, Seoul (KR)

(21) Appl. No.: 18/476,715

(22) Filed: Sep. 28, 2023

(30) Foreign Application Priority Data
Sep. 29, 2022 (KR) 10-2022-0123957

(51) Int. Cl. G06F 40/30

(52) U.S. Cl. CPC G06F 40/30

(57) ABSTRACT

Present disclosure is directed to an electronic device for providing real-time emotional feedback to a user's writing, the electronic device may include a display for displaying a first interface for displaying text information and a second interface for displaying emotion information, and a processor to transmit a first text to a classification server in real-time upon receiving a user input for entering the first text on the first interface, receive a first emotion information about at least one emotion of a virtual audience corresponding to the first text and a generation probability of the at least one emotion through a model. The model is included in the classification server and trained to identify emotions of a virtual audience corresponding to text.

### CROSS-REFERENCE TO RELATED APPLICATION

This application claims priority to and the benefit of Korean Patent Application No. 10-2022-0123957, filed on Sep. 29, 2022 entitled “ELECTRONIC DEVICE FOR PROVIDING REAL-TIME EMOTIONAL FEEDBACK TO USER'S WRITING, METHOD THEREOF AND CLASSIFICATION SEVER FOR ANALYZING REAL-TIME EMOTIONAL FEEDBACK,” the disclosure of which is incorporated herein by reference in its entirety.

### BACKGROUND

### Technical Field

The present disclosure relates to an electronic device for providing real-time emotional feedback to a user's text, a method thereof, and a classification server for analyzing emotional feedback.

### Description of Related Technology

A letter of self-introduction is a type of a form of writing that reveals individual's experiences and thoughts. For example, the letter of self-introduction is often utilized by individuals, such as job candidates, school admission applicants, and others, with the aim to present themselves effectively and create a positive initial impression. When writing the self-introduction letter, the individuals (e.g., the writers) may outline their personal experiences, characteristics, and values. For example, the individuals may answer queries like “Explain your strengths and weaknesses.” or “What difficulties have you experienced and how have you solved them?,” etc.

The individuals are required to write a well-organized and coherent story (e.g., narrative) based on their own experiences and thoughts, and in this process, they must actively participate in self-disclosure, which can fundamentally influence the quality of their self-introduction.

However, it can be challenging for individuals to write the letter of the self-introduction by relying purely on their imagination to know how the interviewer and other readers perceive their writing objectively. That is, having to disclose personal stories to anonymous readers (e.g., unknown readers) without knowing the reader's reaction can create uncertainty and concerns about how others perceive their stories.

Studies have shown that audience reactions, which affect personal perceptions of social acceptance, help the individuals in making appropriate self-disclosures. The future interactions that are expected even without the actual reader's (e.g., listener's) reaction can increase the cognitive processing of writing and help the individuals (e.g., writers) objectively perceive the information they are reaching.

Thus, it is necessary and important to explore how to induce self-disclosure in text communication so that people can overcome the difficulty of self-disclosure. The disclosure of this section is to provide background information relating to the present disclosure. Applicant does not admit that any information contained in this section constitutes prior art.

### SUMMARY

This disclosure is directed to an electronic device and a method for inducing more self-disclosure through a virtual audience reaction to a user's writing.

This disclosure provides an artificial intelligence (AI)-assisted virtual agent interface for providing real-time emotional feedback to a user's writing.

According to an aspect of the disclosure, an electronic device is configured to provide real-time emotional feedback(s) to a user's writing, and the electronic device may include: a display configured to display a first interface for displaying text information and a second interface for displaying emotion information; and a processor configured to: transmit a first text to a classification server in real-time upon receiving a user input for entering the first text on the first interface, receive a first emotion information about at least one emotion of a virtual audience corresponding to the first text and a generation probability of the at least one emotion through a model, wherein the model is included in the classification server and trained to identify emotions of a virtual audience corresponding to text; control the display to display an emoticon and the generation probability corresponding to the at least one emotion of the virtual audience on the second interface based on the first emotion information.

The processor may display the emoticon and the generation probability corresponding to each of the emotions on the second interface in an order of a high generation probability among the plurality of emotions when the first emotion information includes a plurality of emotions of the virtual audience.

The processor may display some of the emotions with a high generation probability among the plurality of emotions on the second interface as emoticons and probabilities, and display the remaining emotions as texts and probabilities corresponding to the emotions when the first emotion information includes a plurality of emotions of the virtual audience on the second interface.

The model may be a bi-directional Long Short-Term Memory (LSTM) model.

According to an aspect of the disclosure, a method is provided for providing real-time emotional feedback to a user's writing. In some embodiments, the method is performed by an electronic device, and the method may include: transmitting a first text to a classification server in real-time upon receiving a user input for entering the first text on the first interface for displaying text information, receiving a first emotion information about at least one emotion of a virtual audience corresponding to the first text and a generation probability of the at least one emotion through a model, wherein the model is included in the classification server and trained to identify emotions of a virtual audience corresponding to text, and displaying an emoticon and the generation probability corresponding to the at least one emotion of the virtual audience on the second interface for displaying emotion information based on the first emotion information.

The displaying the emoticon and the probability on the second interface may include: when the first emotion information includes a plurality of emotions of a virtual audience, displaying the emoticon and the generation probability corresponding to each of the emotion on the second interface in order of a high generation probability of among the plurality of emotions.

The displaying the emoticon and the probability on the second interface may include: when the first emotion information includes a plurality of emotions of a virtual audience, displaying some of the emotions with a high generation probability among the plurality of emotions on the second interface as emoticons and probabilities, and displaying the remaining emotions as texts and probabilities corresponding to the emotions when the first emotion information includes a plurality of emotions of a virtual audience on the second interface.

According to an aspect of the present disclosure, a classification server is provided for analyzing real-time emotional feedback to a user's writing. The classification server may include: a server processor configured to: receive a first text in real-time from a first electronic device among a plurality of electronic devices communicatively connected to the classification server, identify a first emotion information about at least one emotion of a virtual audience corresponding to the first text and a generation probability of the at least one emotion through a model, wherein the model is trained to identify emotions of a virtual audience corresponding to the received text in real-time, and transmit the first emotional information to the first electronic device.

The server processor may identify a relationship between words included in the text based on bi-directional LSTMs included in the LSTM model analyzing texts in different directions, and identify emotions of the virtual audience based on contributions of the words included in the text.

According to an embodiment of the present disclosure, a user can confirm a reaction of a virtual audience in real-time while writing his/her own text, and thus may help to overcome low uncertainty in text communication and induce the user's self-disclosure.

According to an embodiment of the present disclosure, by displaying high-level emotions with a higher generation probability than displaying all analyzed emotions, it is possible to help the user not to be distracted, and to more intuitively check the reaction of the virtual audience.

According to an embodiment of the present disclosure, the model was compactly designed by adjusting the dimension of the embedding layer, the number of emotion labels, and the like, and it is possible to provide faster and more accurate feedback even when there are many requests for emotion feedback according to text input.

### BRIEF DESCRIPTION OF THE DRAWINGS

FIG. 1 is a diagram illustrating an interface according to an embodiment of the present disclosure.

FIG. 2 is a block diagram illustrating a configuration of an electronic device and a classification server according to an embodiment of the present disclosure.

FIG. 3 is a flowchart illustrating an operation of an electronic device according to an embodiment of the present disclosure.

FIG. 4 is a diagram illustrating an operation of an LSTM model according to an embodiment of the present disclosure.

FIG. 5 is a diagram illustrating an operation between an electronic device and a classification server according to an embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. In the drawings, similar symbols typically identify similar components unless context dictates otherwise. Thus, in some embodiments, part numbers may be used for similar components in multiple figures, or part numbers may vary from figure to figure. Some embodiments may be utilized, and other changes may be made without departing from the spirit or scope of the subject matter presented here. It will be readily understood that the aspects of the present disclosure, as generally described herein and illustrated in the Figures, can be arranged, substituted, combined, and designed in a wide variety of different configurations, all of which are explicitly contemplated and made part of this disclosure.

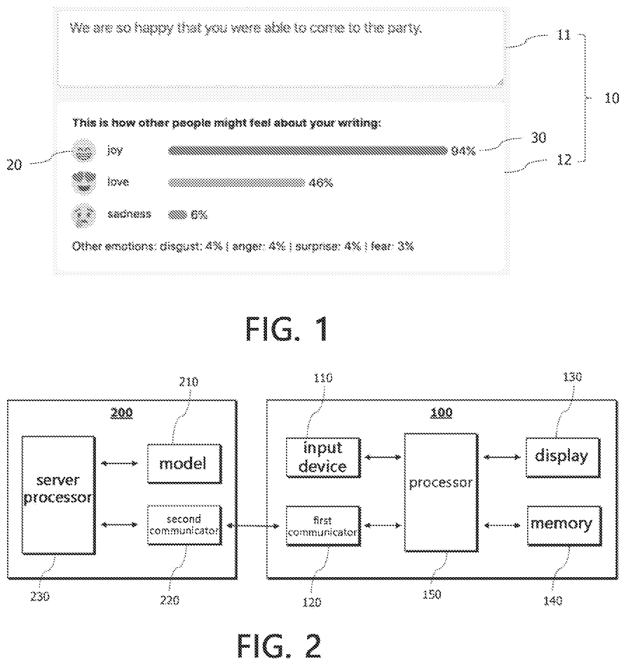

FIG. 1 is a diagram showing an example interface according to an embodiment of the present disclosure. FIG. 1 also illustrates an artificial intelligence (AI)-supported virtual agent interface 10 according to an embodiment of the present disclosure.

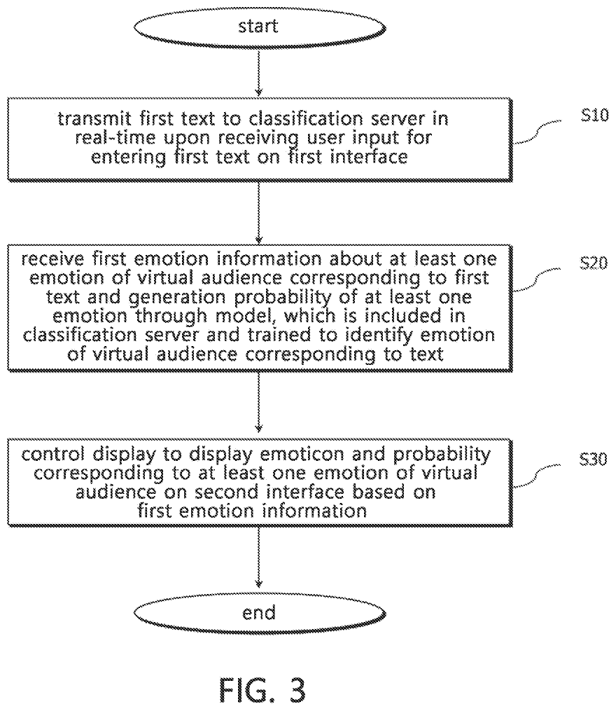

The interface 10 can include a first interface 11 for displaying text information and a second interface 12 for displaying emotion information. For example, when a user writes text on the first interface 11, a reaction of the virtual audience to the writing may be displayed on the second interface 12 in real-time. In some embodiments, the reaction of the virtual audience can be expressed as an emoticon 20 corresponding to the emotion and the probability 30 that the emotion will be generated. Details of the second interface 12 will be described with reference to FIG. 3.

An outer shape and configuration of the interface 10 shown in FIG. 1 are merely provided as an example, and it is sufficient to include a space for writing the text and a space for displaying the reaction of the virtual audience accordingly.

Traditionally, when a user writes for an audience that the user can't see, it is difficult to accurately understand the audience, which can lead to fear of being misunderstood or difficulties with self-disclosure.

To resolve at least these deficiencies, the present disclosure proposes an electronic device that provides real-time emotional feedback to the user's writing and a classification server that analyzes real-time emotional feedback on user's writing so that the user can confirm a reaction of the virtual audience in the process of writing and induce active self-disclosure.

Hereinafter, a configuration and operation of the electronic device and the classification server according to an embodiment of the present disclosure will be described in detail with reference to the drawings.

FIG. 2 illustrates a block diagram of an electronic device 100 and a classification server 200 according to an embodiment of the present disclosure.

The electronic device 100, according to an embodiment of the present disclosure, can be a device for receiving the emotion of a virtual audience according to a text input and displaying the received emotion on the interface 10. The electronic device 100 can also be implemented as a device having a display. For example, the electronic device 100 may be implemented as a smart phone, a tablet PC, a smart pad, a desktop PC, a laptop computer, a TV, and the like.

The electronic device 100, according to an embodiment of the present disclosure, can include an input device 110, a first communicator 120, a display 130, a memory 140, and a processor 150.

The input device 110 can generate input data in response to a user input of the electronic device 100. For example, the user input may be a user input for starting the operation of the electronic device 100, and user input for entering text, which may include editing text, such as text modification, copying, pasting, and cropping. And besides, it can be applied without limitation when it is a user input required to receive real-time emotional feedback to a user's text.

The input device 110 includes at least one input means. For example, the input device 110 may include a key board, a key pad, a dome switch, a touch panel, a touch key, a mouse, a menu button, and the like.

The first communicator 120 may communicate with an external device, such as a classification server 200, to transmit text and receive emotion information corresponding to the text. To this end, the first communicator 120 may perform wireless communication, such as 5th generation communication (5G), long term evolution-advanced (LTE-A), long term evolution (LTE), and wireless fidelity (Wi-Fi), or wired communication, such as a local area network (LAN), a wide area network (WAN), and power line communication.

The display 130 displays data (e.g., display data) according to an operation of the electronic device 100. In some embodiments, the display 130 may display a screen for displaying the first interface for displaying the text information and the second interface for displaying the emotion information.

The display 130 can include a liquid crystal display (LCD), a light emitting diode (LED) display, an organic light emitting diode (OLED) display, a micro electro mechanical systems (MEMS) display, and an electronic paper display. The display 130 may be combined with the input device 110 to be implemented as a touch screen.

The memory 140 may store operation programs of the electronic device 100. The memory 140 can include a storage of a non-volatile property capable of preserving data (information) regardless of whether power is provided or not, and a memory of a volatile property in which data to be processed by the processor 150 is loaded and data cannot be preserved unless power is supplied. The storage may include a flash memory, a hard-disc drive (HDD), a solid-state drive (SSD) read only memory (ROM), and the like, and the memory may include a buffer, a random access memory (RAM), and the like.

The memory 140 may store an emotion information received from the classification server 200. The memory 140 may store the emotion information received from the classification server 200, or may store a computing program necessary in a process of transmitting text to the classification server in real-time, receiving the emotion information, displaying on an interface, and the like.

The processor 150 may execute software such as a program to control at least one other component (e.g., a hardware or software component) of the electronic device 100 and perform various data processing or computing.

The processor 150 according to an embodiment of the present disclosure may transmit a first text to a classification server in real-time upon receiving a user input for entering the first text on the first interface, receive a first emotion information about at least one emotion of a virtual audience corresponding to the first text and a generation probability of the emotion through a model, wherein the model is included in the classification server and trained to identify emotions of a virtual audience corresponding to text, and control the display 130 to display an emoticon and the probability corresponding to the at least one emotion of the virtual audience on the second interface based on the first emotion information.

In some embodiments, the processor 150 may perform at least some of data analysis, processing, and result information generation for performing the above operations using at least one of machine learning, neural network, or deep learning algorithm as a rule-based or artificial intelligence algorithm. Examples of the neural network may include a model such as a convolutional neural network (CNN), a deep neural network (DNN), and a recurrent neural network (RNN).

The classification server 200, according to an embodiment of the present disclosure can be a device for analyzing real-time emotion feedback to a user's text, and can include a model 210, a second communicator 220, and a server processor 230.

The model 210, according to an embodiment of the present disclosure, can be a model learned to identify emotions of a virtual audience corresponding to text. With non-limiting examples, the server processor 230 may learn the model 210 or may receive and store the model 210 previously trained and generated from the outside to use the model 210.

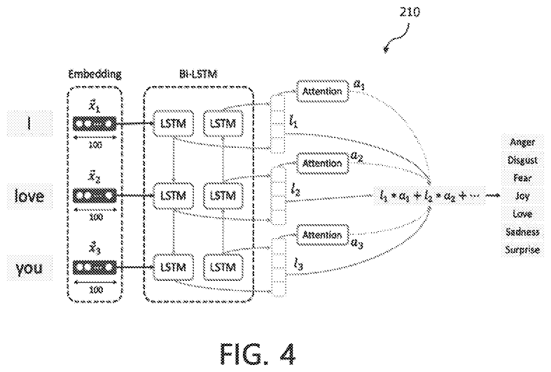

The model 210 may be implemented as a bi-directional Long Short-Term Memory (LSTM) model, and details thereof will be described with reference to FIG. 4.

The second communicator 220 performs communication with an external device such as the electronic device 100 or a server to transmit emotion information and the like. To this end, the second communicator 220 may perform wireless communication such as 5th generation communication (5G), long term evolution-advanced (LTE-A), long term evolution (LTE), and wireless fidelity (Wi-Fi), or wired communication such as a local area network (LAN), a wide area network (WAN), and power line communication.

The server processor 230 may execute software such as a program to control at least one other component (e.g., a hardware or software component) of the classification server 200 and perform various data processing or computing.

The server processor 230, according to an embodiment of the present disclosure, may receive a first text in real-time from a first electronic device among a plurality of electronic devices communicatively connected to the classification server 200, identify a first emotion information about at least one emotion of a virtual audience corresponding to the first text and a generation probability of the emotion through a model, wherein the model is trained to identify emotions of a virtual audience corresponding to the received text in real-time, and transmit the first emotional information to the first electronic device.

In some embodiments, the server processor 230 may perform at least some of data analysis, processing, and result information generation for performing above operations using at least one of machine learning, neural network, or deep learning algorithm as a rule-based or artificial intelligence algorithm. Examples of the neural network may include a model such as a convolutional neural network (CNN), a deep neural network (DNN), and a recurrent neural network (RNN).

FIG. 3 is a flowchart illustrating an example of an operation of the electronic device according to an embodiment of the present disclosure.

According to an embodiment of the present disclosure, the processor 150 may transmit the first text to the classification server 200 in real-time upon receiving a user input for entering the first text on the first interface 11 (Step 10).

The first interface 11 can be a space in which a user inputs text and may be implemented as a general text space displayed when writing e-mail, text messages, or comments.

According to an embodiment of the present disclosure, whenever the processor 150 receives a user input, the processor 150 may transmit the user input to the classification server 200 in real-time. For example, even if a sentence is not completed, the processor 150 may transmit the user input for each word.

In some examples, when the processor 150 receives the user input for entering, such as “I love you,” “I,” “love,” and “you” may be immediately transmitted to the classification server 200 as soon as they are respectively input. In this example, the processor 150 may recognize the user input for entering the space bar for word spacing by a trigger signal to be transmitted to the classification server 200. However, the present disclosure is not limited thereto and may separately set a criterion for transmitting the text in real-time to the classification server 200.

In some embodiments, the user input for entering the text can include the user input for editing the text, such as text modification, copying, pasting, and cropping, and the processor 150 may immediately transmit the changed text to the classification server 200 whenever receiving the user input for modifying the text.

According to some embodiments of the present disclosure, the processor 150 can receive a first emotion information about at least one emotion of a virtual audience corresponding to the first text and a generation probability of the emotion through a model 210, which can be included in the classification server 200 and trained to identify emotions of a virtual audience corresponding to text (Step 20).

According to some embodiments of the present disclosure, the virtual audience's emotion can include seven emotions: anger, disgust, fear, joy, love, sadness, and surprise. In some embodiments, similar emotions, such as joy and love, can be expressed as happiness, and the kinds of emotions displayed in the interface can be adjusted.

When identifying or discriminating at least one emotion of the virtual audience corresponding to the text and the generation probability of the corresponding emotion using the model 210, the number of emotions (e.g., the number of labels) may affect the accuracy of the model 210. Since the model 210 may have low accuracy in classifying similar types of emotions, the accuracy may be improved as the number of labels decreases.

According to some embodiments of the present disclosure, the emotion information can include at least one emotion of the virtual audience corresponding to the text and a generation probability of the corresponding emotion.

According to some embodiments of the present disclosure, the processor 150 can control the display to display the emoticon and the probability corresponding to the at least one emotion of the virtual audience on the second interface 12 based on the first emotion information (Step 30).

When the first emotion information includes a plurality of emotions of the virtual audience, the processor 150 may display the emoticon and the generation probability of the emoticon on the second interface 12 in an order of a high generation probability of among the plurality of emotions.

When the first emotion information includes a plurality of emotions of the virtual audience, the processor 150 may display some of the emotions with a high generation probability among the plurality of emotions on the second interface 12 as emoticons and probabilities, and display the remaining emotions as texts and probabilities corresponding to the emotions.

For example, referring to FIG. 1, when a user inputs “We are so happy that you were able to come to the party.”, the virtual audience may have various emotions such as joy, love, sadness, and the like with respect to the user's writing.

In this case, the processor 150 may display emoticons and probabilities corresponding to the emotions in the order of joy, love, and sadness having a high generation probability among a plurality of emotions included in the emotion information received from the classification server 200 on the interface 12.

In addition, apart from some emotions with the high generation probability, the remaining emotions, such as disgust, anger, surprise, and fear, can be displayed on the interface 12 as texts and probabilities.

This may help the user not distract the attention by displaying emotions with higher generation probability than the entire emotion analyzed, so that the user may more intuitively confirm the reaction of the virtual audience.

According to some embodiments of the present disclosure, the user may confirm the reaction of the virtual audience in real-time as they write, and thus may help to overcome the low uncertainty in text communication and induce the user's self-disclosure.

FIG. 4 is a diagram illustrating an example of operation of an LSTM model according to an embodiment of the present disclosure. As shown in FIG. 4, a model 210 can be included in the classification server 200 and trained to identify emotions of the virtual audience corresponding to text, as described with reference to Step 20 of FIG. 3.

The model 210 according to an embodiment of the present disclosure can be a multi-label emotion classifier utilizing a bi-directional LSTM having a self-attention mechanism.

The reaction time of the audience may also have a great influence on recognizing the emotions of the virtual audience. In other words, the shorter the reaction time of the audience (e.g., real-time communication), the more people feel empathy. In addition, with respect to communication modes, the use of a synchronous communication method (e.g., instant messaging, video chat) promotes a feeling of being connected to other people and creates positively a self-disclosure relationship. Therefore, the model 210 of the present disclosure can be designed to provide fast prediction results while simultaneously processing thousands of user requests received from an interface connected to an online community actively used by many users.

The model 210 may use a bi-directional LSTM (long short term memory) having an attention layer to classify various emotions of the text.

The text received from the electronic device 100 can be preprocessed. For example, the server processor 230 may remove punctuation marks and hashtags from the received text and converts them into lower case letters. Semantic embedding may represent the semantics (meaning) of the text by mapping a series of input words to a dense vector. In some embodiments, the word embedding layer could be modified and designed to a low dimension in order to further reduce the size of the model 210 while maintaining accuracy.

The server processor 230 may identify a relationship between words included in the text based on the analysis of the bi-directional LSTMs analyzing the text in different directions, for example, one from front to back and the other from back to front.

The server processor 230 may identify emotions of the virtual audience based on the contribution of the words included in the text.

The model 210 may show up-to-date accuracy by using a self-attention mechanism that amplifies the contribution of the most important word. In some embodiments, for a faster processing speed, the model of the present disclosure may adjust the number of emotions and use the adjusted number of emotions.

According to an embodiment of the present disclosure, the model can be efficiently designed by adjusting the dimension of the embedding layer, the number of emotion labels, and the like, and it is also possible to provide faster and more accurate feedback even when there are many requests for emotion feedback according to text input.

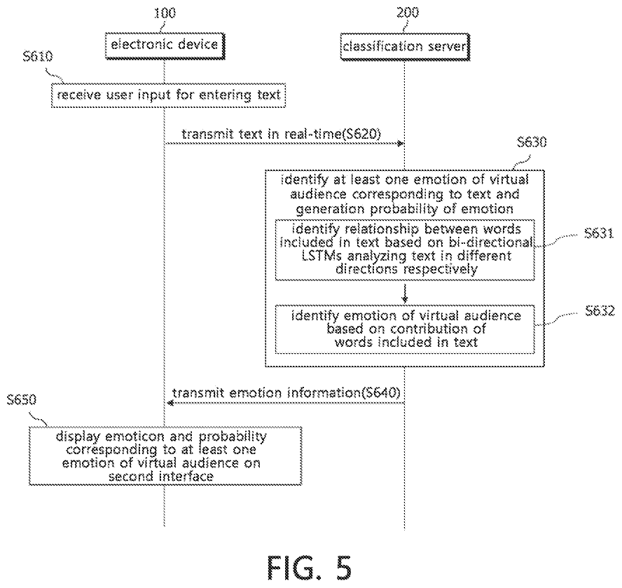

FIG. 5 is a diagram illustrating an operation between an electronic device and a classification server according to an embodiment of the present disclosure.

In some embodiments, a detailed description of the operations of the electronic device 100 and the classification server 200 of FIGS. 3 and 4 can be omitted.

According to an embodiment of the present disclosure, when the electronic device 100 receives a user input for entering text (Step 610), the electronic device 100 can transmit the text to the classification server 200 in real-time as received (Step 620).

The classification server 200 may identify at least one emotion of the virtual audience corresponding to the text and a generation probability of the emotion (Step 630) using the model 210. Specifically, the classification server 200 identifies a relationship between words included in the text based on the bi-directional LSTMs analyzing the text in different directions respectively (Step 631) and identifies the emotion of the virtual audience based on contribution of words included in the text (Step 632).

The classification server 200 can transmit emotion information about at least one emotion of the virtual audience and the generation probability of emotion to the electronic device 100 (Step 640).

The electronic device 100 may display the emoticon and the generation probability corresponding to the at least one emotion of the virtual audience on the second interface based on the emotion information (Step 650).

The elements of a method, process, routine, or algorithm described in connection with the embodiments disclosed herein can be embodied directly in specifically tailored hardware, in a specialized software module executed by an image processing system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. A storage medium can be coupled to the image processing system such that the image processing system can read information from, and write information to, the storage medium. In the alternative, the storage medium can be integral to the image processing system. The DSDN node and the storage medium can reside in an application specific integrated circuit (ASIC). The ASIC can reside in an access device or other monitoring device. In the alternative, the DSDN node and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials according to embodiments of the present invention. Embodiments of this invention are susceptible to modifications in the methods and materials, as well as alterations in the fabrication methods and equipment. Such modifications will become apparent to those skilled in the art from a consideration of this disclosure or practice of embodiments of the invention disclosed herein. Consequently, it is not intended that this invention be limited to the specific embodiments disclosed herein, but that it covers all modifications and alternatives coming within the true scope and spirit of the invention as embodied in the attached claims.

What is claimed is:

1. An electronic device for providing real-time emotional feedback to a user's writing, the electronic device comprising:
a display configured to display a first interface for displaying text information and a second interface for displaying emotion information; and
a processor configured to:
transmit a first text to a classification server in real-time upon receiving a user input for entering the first text on the first interface,
receive a first emotion information about at least one emotion of a virtual audience corresponding to the first text and a generation probability of the at least one emotion through a model, wherein the model is included in the classification server and trained to identify emotions of a virtual audience corresponding to text, and
control the display to display an emoticon and the generation probability corresponding to the at least one emotion of the virtual audience on the second interface based on the first emotion information.

2. The electronic device of claim 1, wherein the processor is configured to: when the first emotion information includes a plurality of emotions of the virtual audience, display the emoticon corresponding to each of the emotion and the generation probability of the emoticon on the second interface in an order of a high generation probability of among the plurality of emotions.

3. The electronic device of claim 2, wherein the processor is configured to: when the first emotion information includes a plurality of emotions of the virtual audience, display some of the emotions with a high generation probability among the plurality of emotions on the second interface as emoticons and probabilities, and display the remaining emotions as texts and probabilities corresponding to the emotions on the second interface.

4. The electronic device of claim 1, wherein the model is a bi-directional Long Short-Term Memory (LSTM) model.

5. A method of providing real-time emotional feedback to a user's writing performed by an electronic device, the method comprising:
transmitting a first text to a classification server in real-time upon receiving a user input for entering the first text on the first interface for displaying text information;
receiving a first emotion information about at least one emotion of a virtual audience corresponding to the first text and a generation probability of the at least one emotion through a model, wherein the model is included in the classification server and trained to identify emotions of a virtual audience corresponding to text; and
displaying an emoticon and the generation probability corresponding to the at least one emotion of the virtual audience on the second interface for displaying emotion information based on the first emotion information.

6. The method of claim 5, wherein displaying the emoticon and the probability on the second interface comprises, when the first emotion information includes a plurality of emotions of a virtual audience, displaying the emoticon and the generation probability corresponding to each of the emotion on the second interface in an order of a high generation probability of among the plurality of emotions.

7. The method of claim 6, wherein displaying the emoticon and the probability on the second interface comprises, when the first emotion information includes a plurality of emotions of a virtual audience, displaying some of the emotions with a high generation probability among the plurality of emotions on the second interface as emoticons and probabilities, and displaying the remaining emotions as texts and probabilities corresponding to the emotions on the second interface.

8. The method of claim 5, wherein the model is a bi-directional Long Short-Term Memory (LSTM) model.

9. A classification server for analyzing real-time emotional feedback to a user's writing, the classification server comprises:
a server processor configured to:
receive a first text in real-time from a first electronic device among a plurality of electronic devices communicatively connected to the classification server,
identify a first emotion information about at least one emotion of a virtual audience corresponding to the first text and a generation probability of at least one the emotion through a model, wherein the model is trained to identify emotions of a virtual audience corresponding to the received text in real-time, and
transmit the first emotional information to the first electronic device.

10. The method of claim 9, wherein the model is a bi-directional Long Short-Term Memory (LSTM) model.

11. The method of claim 10, wherein the server processor is configured to:
identify a relationship between words included in the text based on bi-directional LSTMs included in the LSTM model analyzing texts in different directions, and
identify emotions of the virtual audience based on contributions of the words included in the text.
